(19) United States
(12) Patent Application Publication
(10) Pub. No.: US 2012/0284267 A1
(43) Pub. Date: Nov. 8, 2012

(54) Item Randomization with Item Relational Dependencies

(75) Inventors: Tamer E. Abuelsaad, Poughkeepsie, NY (US); Kelly Abuelsaad, Poughkeepsie, NY (US); Michael J. Forte, Poughkeepsie, NY (US); Zamir G. Gonzalez, Poughkeepsie, NY (US)

(73) Assignee: International Business Machines, Armonk, NY (US)

(21) Appl. No.: 13/102,771

(22) Filed: May 6, 2011

(51) Int. Cl. G06F 17/30

(52) U.S. Cl. 707/737; 707/E17.046

(57) ABSTRACT

An embodiment of the invention provides a method and system for randomizing items within a storage device. A linkage module links a first linked item in the storage device to one or more second linked items in the storage device based on attributes of the items. The linking is performed without input from a user of the storage device. The second linked item has at least one attribute in common with the first linked item. A list generating module connected to the linkage module generates a list, wherein the list includes a random sequence of items. The generating of the list groups the first linked item and the second linked item(s) in the list such that there are no items between the first linked item and the second linked item(s) in the list.

### BACKGROUND

The present invention is in the field of systems, methods, and computer program products for item randomization with item relational dependencies.

Digital media players, such as CD players and MP3 players, often support user functions to manage playback via establishing playlists and playlist modes. The playlist modes typically include a mode to randomize the order of playback of the files, often referred to as “random” or “shuffle.”

Taking the case of audio playback devices, as portable media devices continue to increase in capacity, it is becoming commonplace to have several thousand audio tracks on a playback device. The shuffle feature can therefore draw from a large collection of tracks to provide a unique set of files to play back each time the user listens.

### SUMMARY OF THE INVENTION

An embodiment of the invention provides a method and system for randomizing items within a storage device. A linkage module links a first linked item in the storage device to one or more second linked items in the storage device based on attributes of the items. The linking is performed without input from a user of the storage device. The second linked item has at least one attribute in common with the first linked item. In at least one embodiment, the attribute is the creator of the item (e.g., recording artist, record label, author, publisher, photographer, director, and/or producer). In another embodiment, the second linked item has a first attribute in common with the first linked item and at least one additional attribute in common with the first linked item, wherein the first attribute is the album of the item. In yet another embodiment, the first linked item has a first album attribute, and the second linked item has a second album attribute different from the first album attribute. The attributes further include the date that the item was created, the date that the item was received in the storage device, the date that the item was modified, the size of the item, the type of the item, the format of the item, an individual in the item, and/or a location in the item.

A list generating module connected to the linkage module generates a list, wherein the list includes a random sequence of items. The generating of the list groups the first linked item and the second linked item(s) in the list such that there are no items between the first linked item and the second linked item(s) in the list. The list generating module also determines a sequential order of the first linked item and the second linked item(s) based on the titles of the first linked item and the second linked item(s) and/or the attributes. Thus, the generating of the list positions the first linked item directly before the second linked item(s) or directly after the second linked item(s) based on the sequential order. In at least one embodiment, the sequential order is obtained from an external database.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 illustrates a musical playlist according to an embodiment of the invention;

FIG. 2 illustrates the musical playlist shown in FIG. 1 after a randomization operation according to an embodiment of the invention;

FIG. 3 illustrates a system for randomizing items within a storage device according to an embodiment of the invention;

FIG. 4 is a flow diagram illustrating a method for randomizing items within a storage device according to an embodiment of the invention;

FIG. 5 is a flow diagram illustrating a method for randomizing items within a storage device according to another embodiment of the invention; and

FIG. 6 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

An embodiment of the invention provides a method for allowing randomization/shuffling operations to take place on a set of files. Examples of files (also referred to herein as “items”) include audio files (e.g., MP3, WAV, WMA files), audio-visual files (e.g., MPEG, AVI, Flash video files), images (e.g., JPEG, TIFF, GIF), and text documents (e.g., MIME, .TXT files).

In the scenario of a music playlist, the user may request a shuffle of all his or her playlist entries for a more enhanced listening experience. However, there are songs that should be played back-to-back, such as songs that belong to a “remix” album. A remix album is a musical compilation by an author that does not leave room for breaks between songs, i.e., a meshed song play. Music albums of recorded live performances may also include songs that should be played back-to-back, e.g., the end of one track may reference the following track. To enhance the user's listening experience, it is best to not break the dependencies between such songs when applying a shuffle algorithm. Thus, the randomization/shuffling operations respect the song-to-song established dependencies and do not break the order associated with one or more list items. The user makes use of the randomization feature, which still maintains certain established dependencies.

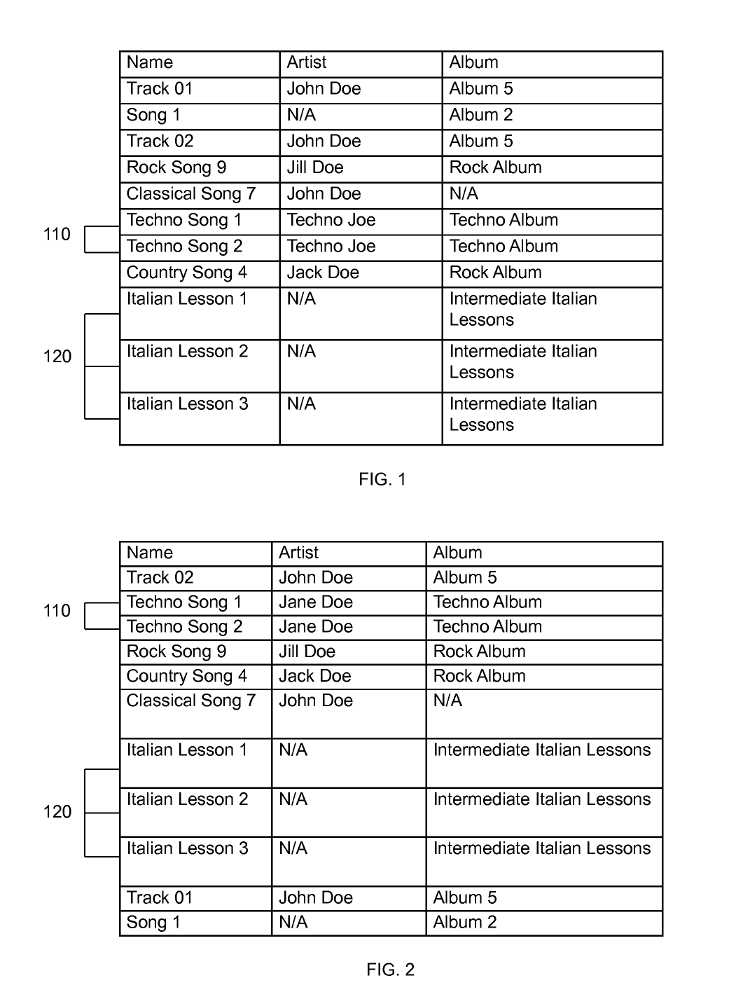

FIG. 1 illustrates a musical playlist according to an embodiment of the invention. The first column includes the name of the media file (i.e., track); the middle column includes the name of the artist; and, the third column lists the albums to which each track belongs to. Dependency 110 shows the linkage between “Techno song 1” and “Techno song 2”. Dependency 120 shows the linkage between “Italian Lesson 1”, “Italian Lesson 2”, and “Italian Lesson 3”.

FIG. 2 illustrates the musical playlist shown in FIG. 1 after a randomization operation according to an embodiment of the invention. The playlist maintains the dependencies 110 and 120 even though the songs were shuffled. As described more fully below, an embodiment of the invention groups files in sequential order based on, for example, the titles of the files.

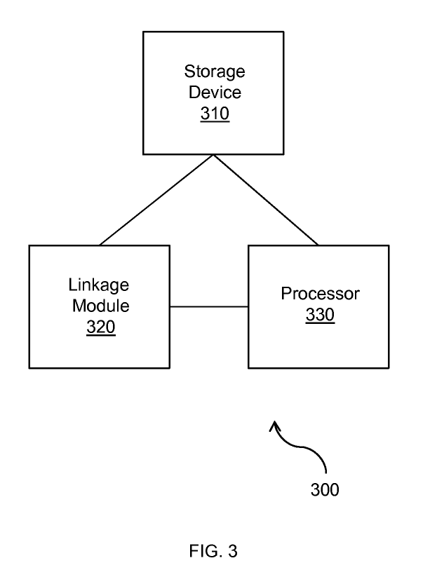

FIG. 3 illustrates a system 300 for randomizing items within a storage device 310 (real or virtual) according to an embodiment of the invention. In at least one embodiment, the storage device 310 is located within a media player (e.g., digital audio player, smart phone, tablet computer). In another embodiment, the storage device 310 is external to the media player.

The items (also referred to herein as “files” or “media files”) have attributes (e.g., metadata). In at least one embodiment, the attributes include the album or collection that the item belongs to, such as the studio album that an audio file is part of (e.g., Thriller, Back in Black, The Wall) or a photo album that an image file is saved in (e.g., “Summer Vacation”, “Birthday Party”, “Graduation”). For example, in at least one embodiment, the items are a series of still photographs of an event, such as a graduate walking across a stage to receive a diploma, or a bride walking down the aisle. An embodiment of the invention links two or more related photographs, such as the graduate walking across the stage without a diploma and the graduate walking across the stage with the diploma, or the bride walking down the aisle with her father and the bride walking up the aisle with the groom.

In another embodiment, the attributes include the creator of the item, such as the recording artist, record label, author, publisher, photographer, director, and/or producer. In yet another embodiment, the attributes include the size of the item, the date that the item was created, the date that the item was received in the storage device, the date that the item was last modified, the type of item, the format of the item (e.g., JPEG, TIFF, GIF, BMP), an individual in the item (e.g., photograph of John Doe), and/or a location in the item (e.g., photograph of Jane Doe in Washington, D.C., photograph of John Doe at GPS coordinates 38.895111, −77.036667).

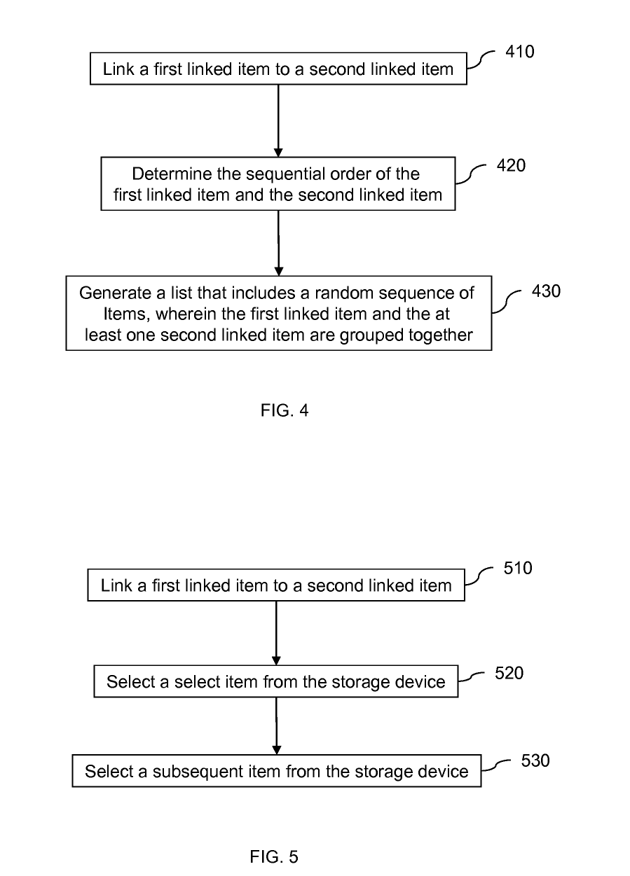

FIG. 4 is a flow diagram illustrating a method for randomizing items within a storage device according to an embodiment of the invention, for example, using the system 300. The system 300 includes a linkage module 320 connected to the storage device 310, wherein the linkage module 320 links a first linked item in the storage device 310 to at least one second linked item in the storage device 310 (410). Referring to the example illustrated in FIG. 1, the linkage module 320 links Italian Lesson 1 (the first linked item) to Italian Lesson 2 and Italian Lesson 3 (the at least one second linked item).

The linkage module 320 performs the linkage without input from a user of the storage device 310. As used herein, the term “user” includes the owner and/or the user of the storage device/media player, e.g., an individual listening to and/or watching a media player who selects the randomization feature. In at least one embodiment, the linkage is based on the attributes, wherein the second linked item(s) have one or more attributes in common with the first linked item. In the previous example, the items are linked because they belong to the same audio lesson (e.g., album). In another example (not illustrated), the linkage module 320 links 4 audio files that are by the same creator (e.g., musical artist).

In at least one embodiment of the invention, the second linked item(s) have two or more attributes in common with the first linked item: the album of the items and at least one additional attribute (e.g., individual(s) in the item). In another embodiment, the first linked item has a first album attribute; and, the second linked item has a second album attribute different from the first album attribute. In other words, the second linked item(s) and the first linked item share at least one common attribute; however, they belong to different albums.

In at least one embodiment of the invention, the attributes that link the items are determined by linkage rules defined by the manufacturer of the media player. For example, in one embodiment, the rules dictate that the linkage module 320 links all audio files from the same album. In another embodiment, the rules dictate that the linkage module 320 links all image files captured from the same location and in time order. In yet another embodiment, the rules are defined by the user.

In at least one embodiment of the invention, the linkage module 320 determines the sequential order of the first linked item and the at least one second linked item based on the titles of the linked items (e.g., Track 1, Lesson 3C, Chapter 15) (420). In another embodiment, the linkage module 320 determines the sequential order of the linked items based on the attributes of the linked items (e.g., the dates that the linked items were created). In yet another embodiment, the sequential order of the linked items is obtained from an external database (e.g., online bookstore, publisher's website, artist's website).

The linkage module 320 is connected to a processor 330 (also referred to herein as a “list generating module”). In at least one embodiment, the processor is also connected to the storage device 310. The processor 330 generates a list that includes a random sequence of items, wherein the first linked item and the at least one second linked item are grouped together within the list such that there are no items between the first linked item and the at least one second linked item in the list (430). In other words, the linked items are grouped together within the list and the items outside of the linked items are shuffled. Thus, for example, if Image File 001 is linked to Image File 002, then during a randomized slideshow, there are no image files displayed between the Image File 001 and the Image File 002. In at least one embodiment of the invention, while generating the list, the processor 330 positions the first linked item directly before or directly after the at least one second linked item based on the sequential order determined by the linkage module 320. Thus, in the previous example, the processor 330 positions Image File 002 directly after Image File 001 based on the numerical order of the titles.

FIG. 5 is a flow diagram illustrating a method for randomizing items within a storage device according to another embodiment of the invention, for example, using the system 300. The linkage module 320 links a first linked item in the storage device 310 to at least one second linked item in the storage device 310 (510). The linkage module 320 performs the linkage without input from a user of the storage device 310. In at least one embodiment, the linkage is based on the attributes, wherein the second linked item(s) have one or more attributes in common with the first linked item. For example, the linkage module 320 links six (6) image files that were created on the same day.

The processor 330 selects a select item from the storage device 310 (e.g., a music track or photograph) (520). The processor 330 selects a subsequent item from the storage device (530). If the select item (i.e., the item selected in 520) is the first linked item, then the processor 330 selects the at least one second linked item as the subsequent item. If the select item is the at least one second linked item, then the processor 330 selects the first linked item as the subsequent item. If the select item is not a linked item, then the processor 330 selects a random item in the storage device 310.

Referring to the example illustrated in FIG. 1, if the select item is Techno Song 1, then the processor 330 selects Techno Song 2 as the subsequent item. If the select item is Techno Song 2, then the processor 330 selects Techno Song 1 as the subsequent item. If the select item is not a linked item, then the processor 330 selects a random item (i.e., any of the eleven (11) items). In another embodiment, the Techno Song 1 links to Techno Song 2, but Techno Song 2 does not link to Techno Song 1. Thus, in this embodiment, if the select item is Techno Song 2, then the processor 330 selects a random item.

As discussed above, an embodiment of the invention determines the sequential order of linked items. Thus, for example, in FIG. 1, the linkage module 320 determines that the Italian Lesson 2 track is played after the Italian Lesson 1 track, and the Italian Lesson 3 track is played after the Italian Lesson 2 track (i.e., the sequential order is Italian Lesson 1—Italian Lesson 2—Italian Lesson 3). In at least one embodiment of the invention, if the select item is a linked item, then the processor 330 selects the first item in the sequential order. Thus, for example, if the processor 330 selects either the Italian Lesson 2 track or the Italian Lesson 3 track, then the processor will play the Italian Lesson 1 track (520). The processor 330 will then play the Italian Lesson 2 track, followed by the Italian Lesson 3 track.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute with the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

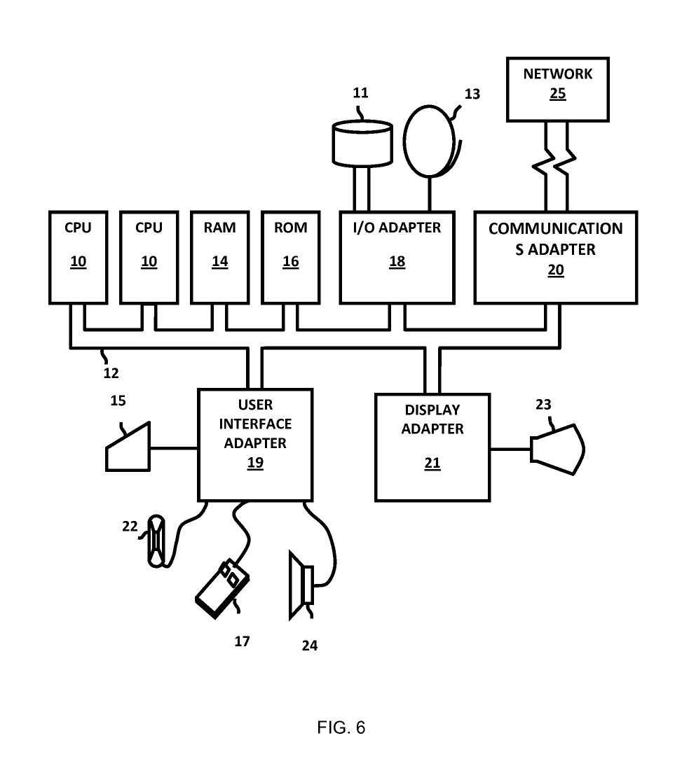

Referring now to FIG. 6, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for randomizing items within a storage device, the items comprising attributes, the method comprising:
linking a first linked item in the storage device to at least one second linked item in the storage device based on the attributes, the second linked item comprising at least one attribute in common with the first linked item, the attribute comprising a creator of the item; and
generating a list with a processor, the list comprising a random sequence of items, the generating of the list including grouping the first linked item and the at least one second linked item in the list such that there are no items between the first linked item and the at least one second linked item in the list.

2. The method according to claim 1, wherein the linking is performed without input from a user of the storage device.

3. The method according to claim 1, wherein the creator of the item comprises at least one of a recording artist, a record label, an author, a publisher, a photographer, a director, and a producer.

4. The method according to claim 1, wherein the attribute further comprises at least one of a date that the item was created, a date that the item was received in the storage device, and a date that the item was modified.

5. The method according to claim 1, wherein the attribute further comprises at least one of an album of the item, a size of the item, a type of the item, a format of the item, an individual in the item, and a location in the item.

6. The method according to claim 1, further comprising determining a sequential order of the first linked item and the at least one second linked item based on at least one of titles of the first linked item and the at least one second linked item and the attributes,
wherein the generating of the list comprises positioning the first linked item one of directly before the at least one second linked item and directly after the at least one second linked item based on the sequential order.

7. The method according to claim 6, wherein the determining of the sequential order comprises obtaining the sequential order from an external database.

8. A method for randomizing items within a storage device, the items comprising attributes, the method comprising:
linking a first linked item in the storage device to at least one second linked item in the storage device based on the attributes, the second linked item comprising a first attribute in common with the first linked item and at least one additional attribute in common with the first linked item, the first attribute comprising an album of the item; and
generating a list with a processor, the list comprising a random sequence of items, the generating of the list including grouping the first linked item and the at least one second linked item in the list such that there are no items between the first linked item and the at least one second linked item in the list.

9. The method according to claim 8, wherein the linking is performed without input from a user of the storage device.

10. The method according to claim 8, wherein the attributes comprise a creator of the item.

11. The method according to claim 8, wherein the attributes comprise at least one of a date that the item was created, a date that the item was received in the storage device, and a date that the item was modified.

12. The method according to claim 8, wherein the attributes comprise at least one of a size of the item, a type of the item, a format of the item, an individual in the item, and a location in the item.

13. The method according to claim 8, further comprising determining a sequential order of the first linked item and the at least one second linked item based on at least one of titles of the first linked item and the at least one second linked item and the attributes,
wherein the generating of the list comprises positioning the first linked item one of directly before the at least one second linked item and directly after the at least one second linked item based on the sequential order.

14. The method according to claim 13, wherein the determining of the sequential order comprises obtaining the sequential order from an external database.

15. A method for randomizing items within a storage device, the items comprising attributes, said method comprising:
linking a first linked item in the storage device to at least one second linked item in the storage device based on the attributes, the second linked item comprising at least one attribute in common with the first linked item, the first linked item comprising a first album attribute, and the second linked item comprising a second album attribute different from the first album attribute; and
generating a list with a processor, the list comprising a random sequence of items, said generating of the list including grouping the first linked item and the at least one second linked item in the list such that there are no items between the first linked item and the at least one second linked item in the list.

16. The method according to claim 15, wherein the linking is performed without input from a user of the storage device.

17. The method according to claim 15, wherein the attributes comprise a creator of the item.

18. The method according to claim 15, wherein the attributes comprise at least one of a date that the item was created, a date that the item was received in the storage device, and a date that the item was modified.

19. The method according to claim 15, wherein the attributes comprise at least one of a size of the item, a type of the item, a format of the item, an individual in the item, and a location in the item.

20. The method according to claim 15, further comprising determining a sequential order of the first linked item and the at least one second linked item based on at least one of titles of the first linked item and the at least one second linked item and the attributes,
wherein the generating of the list comprises positioning the first linked item one of directly before the at least one second linked item and directly after the at least one second linked item based on the sequential order.

21. The method according to claim 20, wherein the determining of the sequential order comprises obtaining the sequential order from an external database.

22. A system for randomizing items within a storage device, the items comprising attributes, said system comprising:
a linkage module connected to said storage device, said linkage module links a first linked item in said storage device to at least one second linked item in said storage device based on the attributes, the second linked item comprising at least one attribute in common with the first linked item, the first linked item comprising a first album attribute, and the second linked item comprising a second album attribute different from the first album attribute; and
a list generating module connected to said linkage module, said list generating module generates a list comprising a random sequence of items, said list generating module groups the first linked item and the at least one second linked item in the list such that there are no items between the first linked item and the at least one second linked item in the list.

23. The system according to claim 22, wherein said linkage module links items without input from a user of said storage device.

24. The system according to claim 22, wherein said linkage module determines a sequential order of the first linked item and the at least one second linked item based on at least one of titles of the first linked item and the at least one second linked item and the attributes, and
wherein said list generating module positions the first linked item one of directly before the at least one second linked item and directly after the at least one second linked item based on the sequential order.

25. The system according to claim 22, wherein the attributes comprise at least two of a creator of the item, a date that the item was created, a date that the item was received in the storage device, a date that the item was modified, a size of the item, a type of the item, a format of the item, an individual in the item, and a location in the item.
